(19) United States
(12) Patent Application Publication
(10) Pub. No.: US 2022/0193993 A1
(43) Pub. Date: Jun. 23, 2022

(54) POWDER BUILD MATERIAL OBJECT LABELS

(71) Applicant: Hewlett-Packard Development Company, L.P., Spring, TX (US)

(72) Inventors: Wei Huang, Palo Alto, CA (US); Craig Peter Sayers, Palo Alto, CA (US); Gary J. Dispoto, Palo Alto, CA (US)

(73) Assignee: Hewlett-Packard Development Company, L.P., Spring, TX (US)

(21) Appl. No.: 17/603,203

(22) PCT Filed: Aug. 5, 2019
(86) PCT No.: PCT/US2019/045156

§ 371 Date: Oct. 12, 2021

(51) Int. Cl. B29C 64/165; B29C 64/209; B29C 64/393; B33Y 10/00; B33Y 30/00; B33Y 50/02

(52) U.S. Cl. CPC B29C 64/165; B29C 64/209; B29C 64/393; B29K 2105/0032; B33Y 30/00; B33Y 50/02; B33Y 10/00

(57) ABSTRACT

In one example in accordance with the present disclosure, an additive manufacturing system is described. The additive manufacturing system includes a build material distributor to deposit layers of powdered build material onto a bed and an agent distributor to form a slice of a three-dimensional (3D) printed object by selectively depositing at least one agent onto a layer of powdered build material. The additive manufacturing system also includes a controller. The controller 1) controls the build material distributor and the agent distributor to form the 3D printed object and 2) controls the agent distributor to form an object label, the object label to be within a body of the 3D printed object with fused material disposed over the object label. The object label does not receive an agent disposed thereon.

### BACKGROUND

Additive manufacturing systems produce three-dimensional (3D) objects by building up layers of material. Some additive manufacturing systems are referred to as “3D printing devices” because they use inkjet or other printing technology to apply some of the manufacturing materials. 3D printing devices and other additive manufacturing devices make it possible to convert a computer-aided design (CAD) model or other digital representation of an object directly into the physical object.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of an additive manufacturing system for forming powder build material object labels, according to an example of the principles described herein.

FIG. 2 is a simplified top view of an additive manufacturing system for forming 3D printed objects and powder build material object labels, according to an example of the principles described herein.

FIGS. 3A-3E are views of an additive manufacturing bed for forming 3D printed objects and powder build material object labels, according to an example of the principles described herein.

FIG. 4 is a flow chart of a method for forming 3D printed objects and powder build material object labels, according to an example of the principles described herein.

FIG. 5 is a flow chart of a method for forming 3D printed objects and powder build material object labels, according to another example of the principles described herein.

FIG. 6 is a side view of a 3D printed object with powder material object labels, according to an example of the principles described herein.

FIG. 7 depicts a non-transitory machine-readable storage medium for forming 3D printed objects and powder build material object labels, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Additive manufacturing systems form a three-dimensional (3D) object through the solidification of layers of a build material. Additive manufacturing systems make objects based on data in a 3D model of the object generated, for example, with a computer-aided drafting (CAD) computer program product. The model data is processed into slices, each slice defining portions of a layer of build material that are to be solidified.

In one example, to form the 3D object, a build material, which may be powder, is deposited on a bed. A fusing agent is then dispensed onto portions of a layer of build material that are to be fused to form a layer of the 3D object. The system that carries out this type of additive manufacturing may be referred to as a powder and fusing agent-based system. The fusing agent disposed in the desired pattern increases the energy absorption of the layer of build material on which the agent is disposed. The build material is then exposed to energy such as electromagnetic radiation. The electromagnetic radiation may include infrared light, laser light, or other suitable electromagnetic radiation. Due to the increased heat absorption properties imparted by the fusing agent, those portions of the build material that have the fusing agent disposed thereon heat to a temperature greater than the fusing temperature for the build material.

Accordingly, as energy is applied to a surface of the build material, the build material that has received the fusing agent, and therefore has increased energy absorption characteristics, fuses while that portion of the build material that has not received the fusing agent remains in powder form. Those portions of the build material that receive the agent and thus have increased heat absorption properties may be referred to as fused portions. By comparison, the applied heat is not so great so as to increase the heat of the portions of the build material that are free of the agent to this fusing temperature. Those portions of the build material that do not receive the agent and thus do not have increased heat absorption properties may be referred to as unfused portions.

Accordingly, a predetermined amount of heat is applied to an entire bed of build material, the portions of the build material that receive the fusing agent, due to the increased heat absorption properties imparted by the fusing agent, fuse and form the object while the unfused portions of the build material are unaffected, i.e., not fused, in the presence of such application of thermal energy. This process is repeated in a layer-wise fashion to generate a 3D object. The unfused portions of material can then be separated from the fused portions, and the unfused portions recycled for subsequent 3D formation operations.

While such additive manufacturing operations have greatly expanded manufacturing and development possibilities, further development may make 3D printing a part of even more industries. For example, labels are placed on manufactured products to communicate a wide variety of information. For example, a product label may provide information about the part and/or the producer of the part. In some examples, the label may be intended to communicate information to a consumer of the part. The product label may also be intended to communicate information to an operator of a downstream manufacturing station. As a particular example, an object may have a serial number to be included on a label. While specific reference is made to particular label information, an object label may include a wide variety of information.

While such labels are undoubtedly useful in the information they can provide to a manufacturer, consumer, or any other individual that comes into contact with the part, such labels may be subject to damage, degradation, or other circumstances which render them unreadable. For example, a label adhered to a surface may peel off due to loss of adhesive properties of the label. In another example, due to external forces on the label, a portion of the label may become unreadable and/or damaged, rendering the entire label useless.

Accordingly, the present specification describes a method of embedding a label in a 3D printed object. As will be described herein, an additive manufacturing system generates embedded information in the body of the 3D printed object itself. Such an object label has a color that contrasts with surrounding material and can be made by additive manufacturing devices that have a single-color capacity.

Specifically, a pattern of build material does not have fusing agent or binding agent deposited thereon. Portions adjacent this pattern however do receive a fusing/binding agent, which fusing/binding agent colors the build material on which it is applied. As the pattern that forms the object label does not have agent deposited thereon, it does not change color. That is, following fusing or hardening by an agent which has a different color than the build material, this portion that does not receive the agent does not change color. A thin covering of fused build material is then formed on top of the pattern of unladen build material. When the distance from the pattern to the object surface is large, the natural light is not able to penetrate through it and reflect out of the part. Therefore, the pattern is invisible. However, when the distance is small enough, the part surface becomes transparent under natural light. As a result, the pattern is visible notwithstanding the thin covering of fused/bound build material between the pattern and the surface of the object. Accordingly, with a single powder material, parts with embedded information can be built, which have many potential industrial applications with cost benefits.

Specifically, the present specification describes an additive manufacturing system. The additive manufacturing system includes a build material distributor to deposit layers of powdered build material onto a bed and an agent distributor to form a slice of a three-dimensional (3D) printed object by selectively depositing at least one agent onto a layer of powdered build material. The additive manufacturing system also includes a controller. The controller 1) controls the build material distributor and the agent distributor to form the 3D printed object and 2) controls the agent distributor to form an object label, the object label to be within a body of the 3D printed object with fused material forming a covering for the object label. In this example, the object label receives less fusing agent disposed thereon than other portions of the object and is visible through the covering.

The present specification also describes a method. According to the method, layers of build material and a fusing agent are sequentially deposited to form slices of a three-dimensional (3D) printed object. Fusing agent is selectively applied in a pattern such that an unladen portion of the pattern defines an object label. Build material is fused between the object label and the surface of the 3D printed object to form a covering such that the label is protected but visible.

The present specification also describes a non-transitory machine-readable storage medium encoded with instructions executable by a processor. The machine-readable storage medium includes instructions. The instructions, when executed by the processor, sequentially form slices of a three-dimensional (3D) printed object and, within 1 millimeter of a surface of the 3D printed object, form an object label that includes unfused material in a pattern. The instructions, also when executed by the processor, resume forming slices of the 3D printed object wherein build material having an agent disposed thereon is between the object label and the surface of the 3D printed object.

Such systems and methods 1) provide for label inclusion on a part that is less susceptible to mechanical damage or other unreadability; 2) provides information associated with the object on the object; 3) does not change the geometry of the part; 4) can be implemented on any 3D printed object; 5) is low-cost; and 6) provides for color contrast without a second powder material or agent. However, it is contemplated that the systems and methods disclosed herein may address other matters and deficiencies in a number of technical areas.

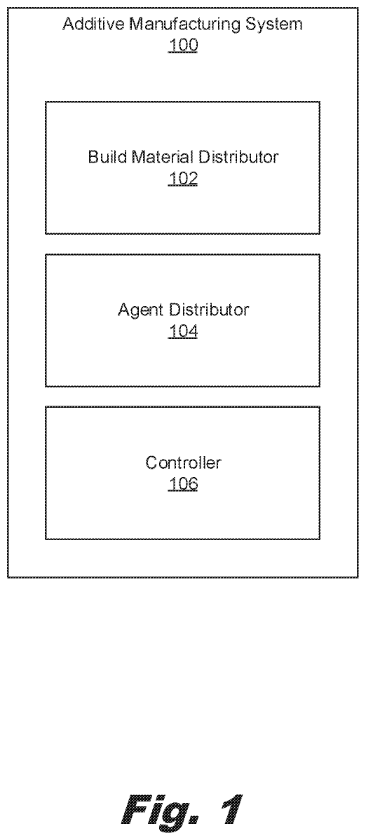

Turning now to the figures, FIG. 1 is a block diagram of an additive manufacturing system (100) for forming powder build material object labels, according to an example of the principles described herein. The additive manufacturing system (100) includes an additive manufacturing device to form a three-dimensional (3D) printed object. As described above, a 3D printed object may be formed using any variety of additive manufacturing systems including a fusing-agent based system. In general, apparatuses for generating three-dimensional objects may be referred to as additive manufacturing systems (100). The additive manufacturing system (100) described herein may correspond to three-dimensional printing systems, which may also be referred to as three-dimensional printers.

In one example, the additive manufacturing system (100) includes a build material distributor (104) to successively deposit layers of the build material onto a bed. Each layer of the build material that is fused in the bed forms a slice of the 3D printed object such that multiple layers of fused build material form the entire 3D printed object.

The additive manufacturing system (100) also includes an agent distributor (106) to form the 3D printed object. The agent distributor (106) does so by depositing at least one agent onto a layer of powdered build material. The agent distributor (106) may distribute a variety of agents. One specific example of an agent is a fusing agent, which increases the energy absorption of portions of the build material that receive the fusing agent to selectively solidify portions of a layer of powdered build material. In this example, the fusing agent may color the build material on which it is deposited. Accordingly, that build material on which the fusing agent is deposited may be one color (e.g., black) and build material on which no fusing agent is deposited may be another color (e.g., white). The agent distributor (106) may deposit other agents as well. For example, a binder agent that temporarily glues portions of the 3D printed object together.

The additive manufacturing system (100) also includes a controller (106). The controller (106) may include various hardware components, which may include a processor and memory. The processor may include the hardware architecture to retrieve executable code from the memory and execute the executable code. As specific examples, the controller as described herein may include computer readable storage medium, computer readable storage medium and a processor, an application specific integrated circuit (ASIC), a semiconductor-based microprocessor, a central processing unit (CPU), and a field-programmable gate array (FPGA), and/or other hardware device.

The memory may include a computer-readable storage medium, which computer-readable storage medium may contain, or store computer usable program code for use by or in connection with an instruction execution system, apparatus, or device. The memory may take many types of memory including volatile and non-volatile memory. For example, the memory may include Random Access Memory (RAM), Read Only Memory (ROM), optical memory disks, and magnetic disks, among others. The executable code may, when executed by the controller (106) cause the controller (106) to implement at least the functionality of interrupting printing and resuming printing as described below.

The controller (106) controls the additive manufacturing. That is, the controller (106) instructs the build material distributor (102) and agent distributor (104) to form the 3D printed object. Specifically, in a fusing agent-based system, the controller (106) may direct the build material distributor (102) to add a layer of build material. Further, the controller (106) may send instructions to direct a printhead of the agent distributor (104) to selectively deposit the agent onto the surface of a layer of the build material. The controller (106) may also direct the printhead to eject the agent at specific locations to form a 3D printed object slice.

In one particular example, the controller (106) controls the agent distributor (104) to form an object label. That is, as described above, an object label may be a pattern of unladen build material. That is, the object label is a pattern of build material within a body of a 3D printed object.

The controller (106) also controls the agent distributor (104) to form a covering of fused material over the object label. The object label receives less fusing agent than other portions of the 3D printed object. In one specific example, no fusing agent is deposited on the object label and the object label is therefore not colored by the aforementioned fusing agent. In another example, the covering receives more fusing agent than the object label portion and less fusing agent than a remainder of the slice. Formation of the object label may include depositing agent in areas outside of the object label portion.

As a specific example, the object label includes alphanumeric characters such as “ABC123.” Such alphanumeric characters may provide human readable information. In this example, the controller (106) controls the agent distributor to outline the “A,” “B,” “C,” 1,” “2,” and “3,” such that an area of the build material surrounding these alphanumeric characters does have fusing agent thereon and therefore are colored by the fusing agent, while these alphanumeric characters themselves do not have fusing agent applied thereon, and therefore remain in the color of the raw build material, which color may be different than a color imparted by the agent.

In another example, the object label includes a machine-readable code such as a matrix code, a barcode, a quick response (QR) code, or any other machine-readable code such as a steganographic marking. In yet another example, the label may be designed for both human and machine readability, for example as an Optical Character Recognition (OCR) font. While reference is made to a few particular types of label formats, the label may be of other types as well.

As the object label portion of the build material does not have fusing agent disposed thereon, the object label itself may be unfused build material, or in the case of application of a binding agent, the object label may be unbonded build material. However, in other examples, the object label may be formed of fused build material or partially-fused build material. That is, as described above, portions of the build material adjacent the object label may have fusing agent disposed thereon and therefore may heat up when exposed to electromagnetic radiation. In this example, due to thermal bleed, heat from adjacent voxels of powder build material may transfer to the voxels that form the object label. Accordingly, these voxels may become fused or partially-fused. However, as there has been no fusing agent formed on these voxels, they remain distinguishable from the adjacent voxels. That is, the voxels that make up the object label retain the intrinsic color of the powder build material (e.g., white) regardless of whether they are fused or unfused, and the voxels that make up other portions of the 3D printed object have the color of the fusing agent (e.g., black).

In another example, the object label portion of the layer of build material may receive some fusing agent, but less fusing agent is applied to those regions than to other portions of the 3D printed object, and thus the object label has a lighter color. In another example, the thin covering between the object label and the surface of the 3D printed object may receive a third level of fusing agent which is more than the object label, but less than the remainder of the object. In some examples additional agents may be used. For example, a functional agent that changes the properties of the powder, such as plasticizer to soften the powder material.

Accordingly, the present additive manufacturing system (100) provides an embedded label that may include any type of information. The label is readable due to its color contrast with other portions of the 3D printed object which surround it which are colored by the agent disposed thereon.

In some examples, the object label is formed within a body of the 3D printed object. Accordingly, following formation of the unfused object label, the controller (106) resumes additive manufacturing. That is, the controller (106) selectively re-activates the build material distributor (102) and the agent distributor (104) to continue the operation of sequentially operating to form slices of a 3D printed object.

In some examples, the object label may be formed within 1 millimeter of a surface of the 3D printed object. That is, a design file for the 3D printed object may indicate that the label is to be near the surface, but still covered by some fused build material. In a more specific example, the object label may be formed within 300 microns of a surface of the printed object. Other examples of distances within which the object label may be formed include 2 millimeters, 0.5 millimeters, and 0.25 millimeters. In some examples, the distance may be smaller, for example 100 microns. Whatever the distance between the object label and the surface of the 3D printed object, the object label itself is covered, at least in part, by build material having a fusing agent applied thereon. In some examples, the distance between the object label and the surface of the 3D printed object may be based on a number of factors including the type of fusing agent and an amount of fusing agent delivered to the covering.

Notwithstanding the placement of fused, and thereby tinted, build material on top of the un-tinted object label, the object label is still visible through the covering of fused build material. That is, the fused build material is transparent or translucent to a certain depth. Accordingly, by placing the object label near a surface (for example within 1 millimeter or 300 microns), the object label is still visible in natural lighting due to the color difference between 1) the object label which has not had fusing agent deposited thereon and is thereby the color of the raw build material and 2) surrounding build material which has had fusing agent deposited thereon and is thereby a color determined by the fusing/binding agent.

As described above, object labels communicate a variety of information to different users. For example, the object label may include an indication that a particular part satisfies certain quality metrics and may provide tracking information such that a particular source and/or batch associated with the product may be identified. Such information may also be used in servicing the product. For example, the label may include a model number or product specific ID to facilitate servicing of the product at a later point in time. That is, the object label may include a unique object identifier.

Accordingly, the present system (100) provides a label that is embedded in the part, yet is readable outside of the part due to color contrast between the unladen object label portion of build material and the surrounding build material which has received an agent thereon. The object label is also protected from mechanical damage by being disposed underneath a thin covering of fused material, for example less than 1 millimeter, which fused material resists mechanical damage.

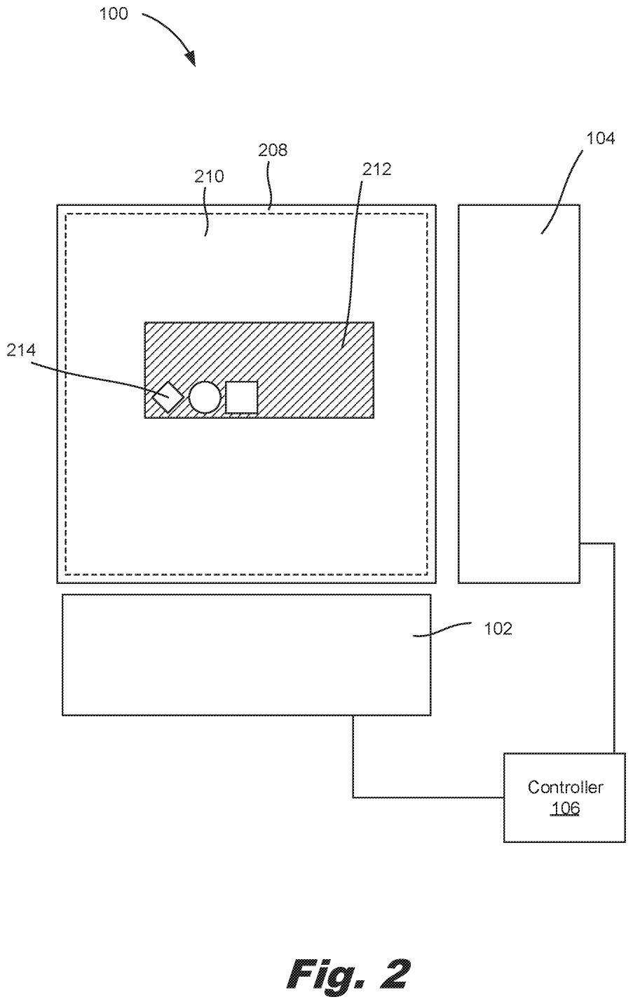

FIG. 2 is a simplified top view of an additive manufacturing system (100) for forming 3D printed objects (212) and powder build material object labels (214), according to an example of the principles described herein. In general, apparatuses for generating three-dimensional objects may be referred to as additive manufacturing systems (100). The additive manufacturing system (100) described herein may correspond to three-dimensional printing systems, which may also be referred to as three-dimensional printers. An additive manufacturing system (100) may use a variety of operations. For example, the additive manufacturing system (100) may be a fusing agent-based system (as depicted in FIG. 2) or a binding-agent based system. While FIG. 2 depicts a specific example of an agent-based system (100), the additive manufacturing system (100) may be any of the above-mentioned systems (100) or another type of additive manufacturing system (100).

In an example of an additive manufacturing process, a layer of build material may be formed in a build area (210). As used in the present specification and in the appended claims, the term “build area” refers to an area of space wherein the 3D printed object (212) is formed. The build area (210) may refer to a space bounded by a bed (208). The build area (210) may be defined as a three-dimensional space in which the additive manufacturing system (100) can fabricate, produce, or otherwise generate a 3D printed object (212). That is, the build area (210) may occupy a three-dimensional space on top of the bed (208) surface. In one example, the width and length of the build area (210) can be the width and the length of bed (208) and the height of the build area (210) can be the extent to which bed (208) can be moved in the z direction. Although not shown, an actuator, such as a piston, can control the vertical position of bed (208).

The bed (208) may accommodate any number of layers of build material. For example, the bed (208) may accommodate up to 4,000 layers or more. In an example, a number of build material supply receptacles may be positioned alongside the bed (208). Such build material supply receptacles source the build material that is placed on the bed (208) in a layer-wise fashion.

In FIG. 2 and others, the 3D printed object (212) is indicated in a patterned fill to distinguish the powder build material with agent disposed thereon as compared to the raw powder build material that surrounds it and that makes up the object label (214).

In the additive manufacturing process, any number of functional agents may be deposited on the layer of build material. One such example is a fusing agent that facilitates the hardening of the powder build material. In this specific example, the fusing agent may be selectively distributed on the layer of build material in a pattern of a layer of a 3D object. An energy source may temporarily apply energy to the layer of build material. The energy can be absorbed selectively into patterned areas formed by the fusing agent, while blank areas that have no fusing agent absorb less applied energy. This leads to selected zones of a layer of build material selectively fusing together. This process is then repeated, for multiple layers, until a complete physical object has been formed. As described above, the fusing agent may be of any color such that the build material on which the fusing agent is deposited, takes on the color of the fusing agent whereas the raw build material—that is the build material with no fusing/binding agent disposed thereon—remains an intrinsic color which is different than the color of the fusing agent.

Additional layers may be formed and the operations described above may be performed for each layer to thereby generate a three-dimensional printed object (212). The layer-by-layer formation of a three-dimensional object (212) may be referred to as a layer-wise additive manufacturing process.

FIG. 2 clearly depicts the build material distributor (102). The build material distributor (102) may acquire build material from build material supply receptacles, and deposit such acquired material as a layer in the bed (208), which layer may be deposited on top of other layers of build material already processed that reside in the bed (208).

In some examples, the build material distributor (102) may be coupled to a scanning carriage. In operation, the build material distributor (102) places build material in the build area (210) as the scanning carriage moves over the build area (210) along the scanning axis. While FIG. 2 depicts the build material distributor (102) as being orthogonal to the agent distributor (104), in some examples the build material distributor (102) may be in line with the agent distributor (104).

FIG. 2 also depicts the agent distributor (104). In some examples, an agent distributor (104) includes at least one liquid ejection device to distribute a functional agent onto the layers of build material. A liquid ejection device may include at least one printhead (e.g., a thermal ejection based printhead, a piezoelectric ejection based printhead, etc.). In some examples, the agent distributor (104) is coupled to a scanning carriage, and the scanning carriage moves along a scanning axis over the build area (210). In one example, printheads that are used in inkjet printing devices may be used as an agent distributor (104). In this example, the functional agent may be a printing liquid. In other examples, an agent distributor (104) may include other types of liquid ejection devices that selectively eject small volumes of liquid.

As described above, the agent distributor (104) may distribute a variety of agents. One specific example of an agent is a fusing agent, which increases the energy absorption of portions of the build material that receive the fusing agent to selectively solidify portions of a layer of powdered build material.

The agent distributor (104) may deposit other agents as well. For example, the agent distributor (104) may distribute a detailing agent that sharpens the resolution of the object label and prevents thermal bleed from adjacent voxels.

FIG. 2 also depicts the controller (106) which controls the build material distributor (102) and the agent distributor (104) to form the object label (214). For simplicity, in FIG. 2 the object label (214) is depicted as a sequence of a diamond, circle, and square. However, as demonstrated above, the object label (214) may take many forms including alphanumeric characters, shapes, and/or machine-readable code.

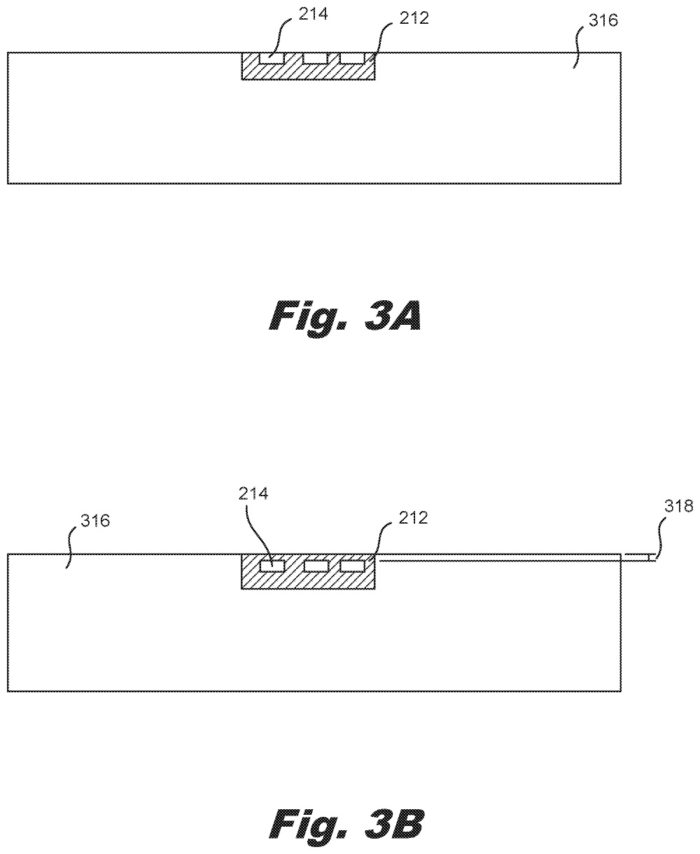

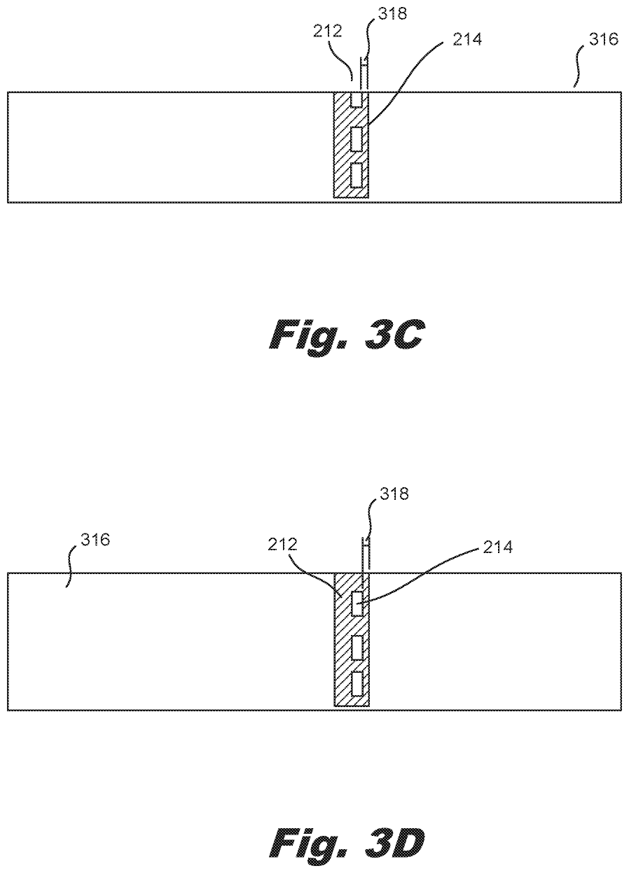

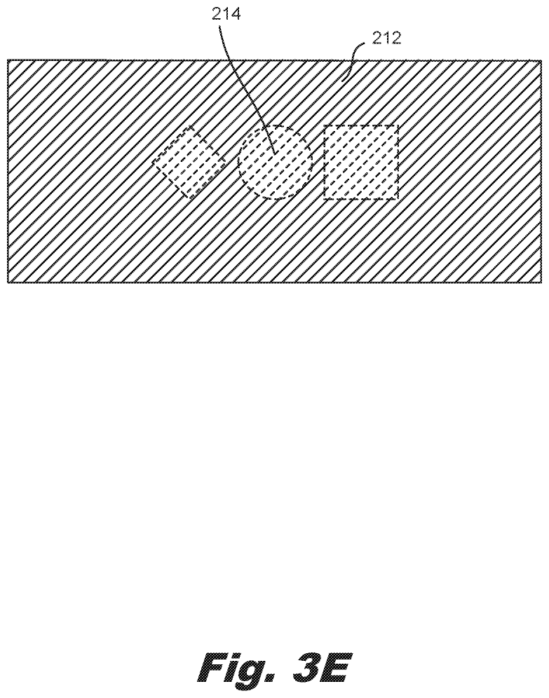

FIGS. 3A-3E are views of an additive manufacturing bed (FIG. 2, 208) for forming 3D printed objects (212) and powder build material object labels (214), according to an example of the principles described herein. Specifically, FIG. 3A depicts formation of the object label (214), FIG. 3B depicts deposition of additional fusing agent over the object label (214), and FIG. 3E depicts a top view of the 3D printed object (212). Note that while FIGS. 3A and 3B depict the object label (214) as being formed on a top surface of the build area (FIG. 2, 210), the object label (214) may be formed vertically, on a side surface of the 3D printed part (212) as depicted in FIGS. 3C and 3D.

As described above, the additive manufacturing operation includes the sequential deposition of layers of a powdered build material (316) that are selectively hardened in a number of ways to form a 3D printed object (212). As described above, during this formation, agent is selectively applied in a pattern such that portions without a fusing agent disposed thereon are surrounded by portions with a fusing agent disposed thereon. The portions without an agent disposed thereon form the object label (214), while those portions with the agent disposed thereon form the 3D printed object (212) in which the object label (214) is disposed. In FIGS. 3A-3D, the patterned fill indicates the 3D printed object (212) which has fusing agent disposed thereon and the un-patterned portion indicates the build material (316) without fusing agent disposed thereon, which unladen portion corresponds to the object label (214) portion and support build material portion.

As described above, following formation of the object label (214) by ejecting agent to define the object label (214), additional layers of the 3D printed object (212) are formed, with some fusing agent being deposited directly over the object label (214) as depicted in FIGS. 3B and 3D. In some examples, the distance (318) between the surface of the object label (214) and the surface of the 3D printed object (212) may be less than 1 millimeter. In some examples, this distance (318) may be less than 300 microns. Such a distance (318) may be defined by a distance, a number of voxels, or a number of layers between the edge of the object label (214) and the surface of the 3D printed object (212). In one example, the distance (318) may be less than ten layers of powdered build material (316), and in some more particular cases may be less than four layers of powdered build material (316).

FIG. 3E depicts a top view of the 3D printed object (212) with the object label (214) formed therein. In FIG. 3E, the build material (FIG. 3A, 316) disposed over the object label (214) is indicated in a dashed pattern fill to indicate the placement of the object label (214) underneath. The dashed pattern indicates the color difference between the object label (214) with raw, or unladen build material (FIG. 3A, 316) and the remaining portions of the 3D printed object (212) which has fusing/binding agent disposed thereon. As depicted in FIGS. 3A-3E build material (FIG. 3A, 316) with agent disposed thereon is directly between the object label (FIG. 2, 214) and the surface of the 3D printed object (FIG. 2, 212).

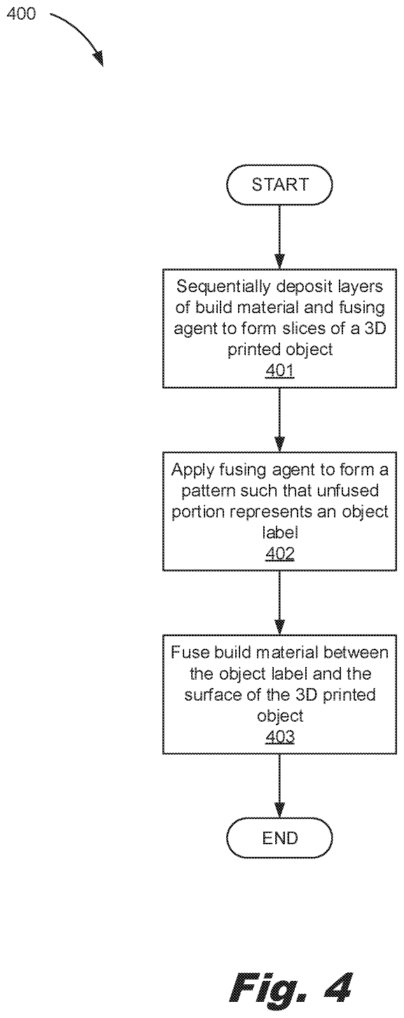

FIG. 4 is a flow chart of a method (400) for forming 3D printed objects (FIG. 2, 212) and powder build material object labels (FIG. 2, 214), according to an example of the principles described herein. As described above, additive manufacturing involves the layer-wise deposition of build material and hardening/curing/sintering/fusing of certain portions of that layer to form a slice of a 3D printed object (FIG. 2, 212). Accordingly, in this example, the method (400) includes sequentially depositing (block 401) layers of build material (FIG. 3, 316) and a fusing agent to form slices of a 3D printed object (FIG. 2, 212). This includes sequential activation, per slice, of a build material distributor (FIG. 1, 102) and an agent distributor (FIG. 1, 104) and the scanning carriages to which they may be coupled so that each distribute its respective composition across the surface.

During additive manufacturing, fusing agent is selectively applied (block 402) in a pattern such that unladen portions, i.e., those portions without any fusing/binding agent, represent an object label (FIG. 2, 214). That is, the controller (FIG. 1, 106) may control fusing agent deposition such that a pattern of build material (FIG. 3, 316) with no fusing agent, and therefore un-tinted, defines the object label (FIG. 2, 214). As described above, this may be done within a threshold distance of the surface of the 3D printed object (FIG. 2, 212). Specifically, within 1 millimeter, 300 microns, 10 voxels, 4 voxels, 10 layers, or 4 layers from the surface. Doing so ensures that the object label (FIG. 2, 214) will be visible in environmental conditions. That is, even with fusing agent-laden build material on top of the object label (FIG. 2, 214), if near enough the surface, the object label (FIG. 2, 214) remains visible through the overlaying fused build material. Accordingly, build material is fused (block 403) between the object label (FIG. 2, 214) and the surface of the 3D printed object (FIG. 2, 212) to form a covering such that the label is protected but visible. This may include successively depositing layers of build material and selectively applying fusing agent thereon. As described above, notwithstanding the additional covering between a surface of the 3D printed object (FIG. 2, 212) and the object label (FIG. 2, 214), the object label (FIG. 2, 214) is still visible due to the transparency of the little amount of fused build material between the object label (FIG. 2, 214) and the 3D printed object (FIG. 2, 212).

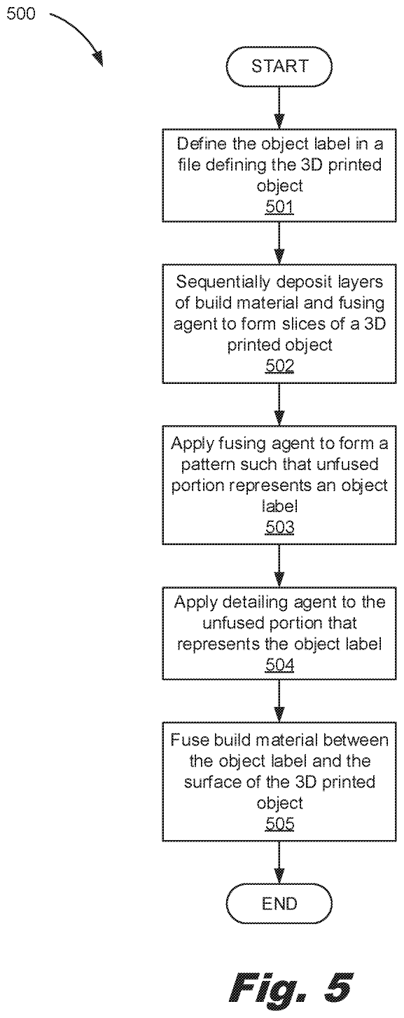

FIG. 5 is a flow chart of a method (500) for forming 3D printed objects (FIG. 2, 212) and powder build material object labels (FIG. 2, 214), according to another example of the principles described herein. In this example, the method (500) includes defining (block 501) the object label (FIG. 2, 214) in a file defining the 3D printed object (FIG. 2, 212). That is, as described above, a computer file may be provided to the additive manufacturing system (FIG. 1, 100) which file defines the characteristics of the 3D printed object (FIG. 2, 212) including tool paths, geometry of the 3D printed object (FIG. 2, 212), and material for the 3D printed object (FIG. 2, 212), among other things. In this example, this same file may define a location and form of the object label (FIG. 2, 214) that is to be formed in the 3D printed object (FIG. 2, 212). Specifically, in this file, a user may define how near to the surface of the 3D printed object (FIG. 2, 212) the object label (FIG. 2, 214) is to be formed.

Based on this file, layers of build material and fusing agent are sequentially deposited (block 502) to form slices of the 3D printed object (FIG. 2, 212) and a fusing agent is selectively applied (block 503) to form a pattern of raw unladen build material that will form the object label (FIG. 2, 214). These operations may be performed as described above in connection with FIG. 4.

In some examples in addition to applying (block 503) the fusing agent in a pattern, a detailing agent is also applied (block 504) to at least a portion of the build material which is to form the object label. While as described above, the portion of the build material to form the object label (FIG. 2, 214) may be fused, it may be desirable for this portion to remain unfused. The detailing agent prevents thermal bleed from adjacent voxels of build material. That is, as build material is fused (block 505) on top of or around the unladen build material that is to form the object label (FIG. 2, 214), the detailing agent prevents the adjacent unfused build material, which is to form the object label (FIG. 2, 214), from hardening.

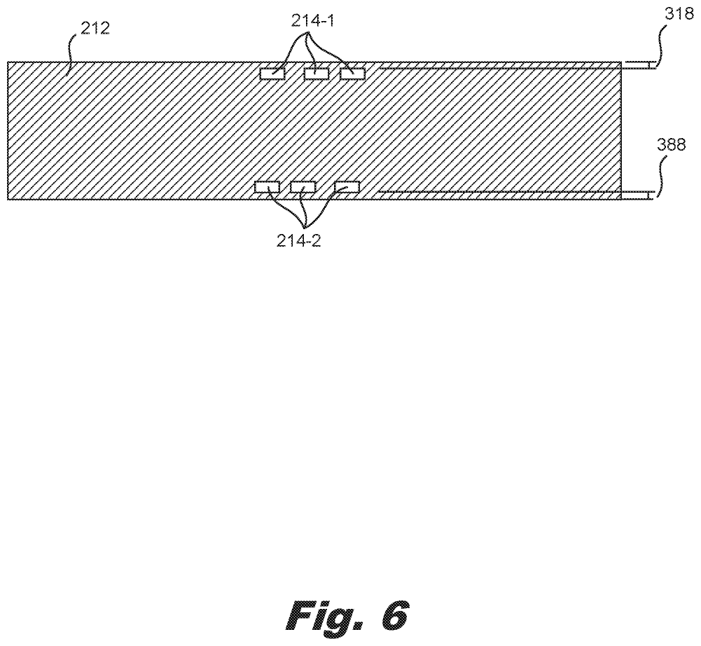

FIG. 6 Depicts a side view of a 3D printed object (212). In this example, there are two identical copies of the label (214-1, 214-2) on opposite sides of the 3D printed object (212), each containing regions which are not fully-fused and covered by fused material. That is, in some examples, multiple copies of the object label (214) are formed on the 3D printed object (212), and in an a more specific example, different of the multiple copies being formed on opposite sides of the 3D printed object.

During the process of converting a digital model into a 3D printed object (212), the digital model is sliced into printable layers to form a physical 3D printed object (212). Since that process may be different for each instance, the exact thickness of the material between the object labels (214) and the surface of the 3D printed object (212) may be difficult to predict in advance. However, by placing multiple copies of the object label (214-1, 214-2) in different orientations it is more likely that at least one of the object labels (214-1, 214-2) will be readable. In one example, the thickness of the 3D printed object (212) and thickness of the layers over the object label (214) are all chosen to be very close to a multiple of the print layer thickness. As a result, regardless of how the 3D printed object (212) is sliced into layers, if the top layer becomes a little thinner, then the bottom layer will become a little thicker, and vice-versa. Thus allowing at least one of the object labels (214-1, 214-2) to be readable.

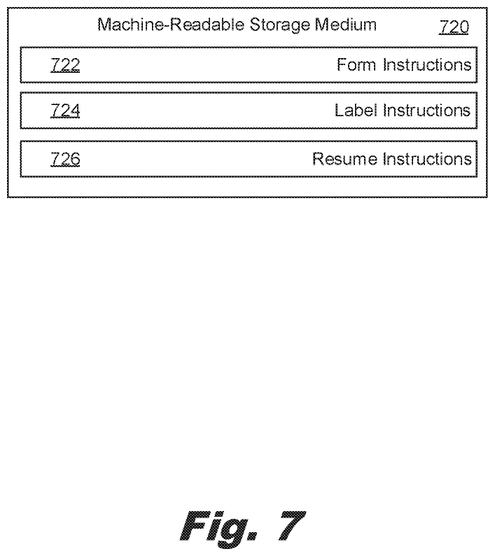

FIG. 7 depicts a non-transitory machine-readable storage medium (720) for forming 3D printed objects (FIG. 2, 212) and powder build material object labels (FIG. 2, 214), according to an example of the principles described herein. To achieve its desired functionality, a computing system includes various hardware components. Specifically, a computing system includes a processor and a machine-readable storage medium (720). The machine-readable storage medium (720) is communicatively coupled to the processor. The machine-readable storage medium (720) includes a number of instructions (722, 724, 726) for performing a designated function. The machine-readable storage medium (720) causes the processor to execute the designated function of the instructions (722, 724, 726). The machine-readable storage medium (720) can store data, programs, instructions, or any other machine-readable data that can be utilized to operate the additive manufacturing system (FIG. 1, 100). Machine-readable storage medium (720) can store computer readable instructions that the processor of the controller (FIG. 1, 106) can process, or execute. The machine-readable storage medium (720) can be an electronic, magnetic, optical, or other physical storage device that contains or stores executable instructions. Machine-readable storage medium (720) may be, for example, Random Access Memory (RAM), an Electrically Erasable Programmable Read-Only Memory (EEPROM), a storage device, an optical disc, etc. The machine-readable storage medium (720) may be a non-transitory machine-readable storage medium (720).

Referring to FIG. 7, form instructions (724), when executed by the processor, cause the processor to sequentially form slices of a three-dimensional (3D) printed object (FIG. 2, 212). Label instructions (724), when executed by the processor, may cause the processor to, within 1 millimeter of a surface of the 3D printed object (FIG. 2, 212), form an object label (FIG. 2, 214) that includes build material unladen with agent, in a pattern. Resume instructions (726), when executed by the processor, may cause the processor to resume forming slices of the 3D printed object (FIG. 2, 212) wherein build material having an agent disposed thereon is between the object label (FIG. 2, 214) and the surface of the 3D printed object (FIG. 2, 212).

Such systems and methods 1) provide for label inclusion on a part that is less susceptible to mechanical damage or other unreadability; 2) provides information associated with the object on the object; 3) does not change the geometry of the part; 4) can be implemented on any 3D printed object; 5) is low-cost; and 6) provides for color contrast without a second powder material or agent. However, it is contemplated that the systems and methods disclosed herein may address other matters and deficiencies in a number of technical areas.

What is claimed is:

1. An additive manufacturing system, comprising:
a build material distributor to deposit layers of powdered build material onto a bed;
an agent distributor to form a slice of a three-dimensional (3D) printed object by selectively depositing at least one agent onto a layer of powdered build material; and
a controller to:
control the build material distributor and the agent distributor to form the 3D printed object; and
control the agent distributor to form an object label, the object label to be within a body of the 3D printed object with fused material forming a covering for the object label, wherein:
the object label receives less fusing agent disposed thereon than other portions of the 3D printed object; and
the object label is visible through the covering.

2. The additive manufacturing system of claim 1, wherein no fusing agent is deposited on the object label.

3. The additive manufacturing system of claim 1, wherein the covering receives more fusing agent than the object label portion and less fusing agent than a remainder of the slice.

4. The additive manufacturing system of claim 1, wherein the object label is formed of at least one of fused build material, partially-fused build material, unfused build material, and unbonded build material.

5. The additive manufacturing system of claim 1, wherein the object label comprises a unique object identifier.

6. The additive manufacturing system of claim 1, wherein:
the agent comprises a fusing agent;
the fusing agent is to color the build material on which it is deposited such that unfused build material has a different color than fused build material.

7. A method, comprising:
sequentially depositing layers of build material and a fusing agent to form slices of a three-dimensional (3D) printed object;
selectively applying fusing agent in a pattern such that unladen portions of the pattern present an object label; and
fusing build material between the object label and the surface of the 3D printed object to form a covering such that the label is protected but visible.

8. The method of claim 7, wherein the covering between the object layer and the surface of the 3D printed object is less than 1 millimeter thick.

9. The method of claim 7, wherein multiple copies of the object label are formed on the 3D printed object.

10. The method of claim 9, wherein different of the multiple copies are formed on opposite sides of the 3D printed object.

11. The method of claim 7, further comprising applying a detailing agent to at least a portion of the unladen portion of build material which is to form the object label.

12. The method of claim 7, further comprising defining the object label in a file defining the 3D printed object.

13. A non-transitory machine-readable storage medium encoded with instructions executable by a processor, the machine-readable storage medium comprising instructions to:
sequentially form slices of a three-dimensional (3D) printed object;
within 1 millimeters of a surface of the 3D printed object, form an object label that comprises unladen build material in a pattern; and
resume forming slices of the 3D printed object wherein build material having an agent disposed thereon is between the object label and the surface of the 3D printed object.

14. The non-transitory machine-readable storage medium of claim 13, wherein the object label comprises alphanumeric characters.

15. The non-transitory machine-readable storage medium of claim 13, wherein the object label comprises a machine-readable code.
